(19) United States
(12) Patent Application Publication
(10) Pub. No.: US 2006/0285931 A1
(43) Pub. Date: Dec. 21, 2006

(54) Combination drill guide and clamping device

(76) Inventor: Dennis C. Dean, Canyon Country, CA (US)

Correspondence Address: LOUIS L. DACHS, 1794 PALISADES DRIVE, PACIFIC PALISADES, CA, 90272, US

(21) Appl. No.: 11/154,311

(22) Filed: Jun. 16, 2005

(51) Int. Cl. B23B 47/28

(52) U.S. Cl. 408/103

(57) ABSTRACT

The invention is a device for drilling a structure having a pilot hole there through. The device includes a support member having first and second opposed ends, the first and second opposed ends having aligned first and second holes, respectively there through, with the first hole having internal threads. A drill guide is threadably engagable with the threaded hole in the first opposed end of the support member, the drill guide having a hole there through. A positioning member having a pin, the positioning member insertable into the hole of either the drill guide or the hole in the second opposed end, such that when the structure is positioned between the first and second opposed ends, the pin of the positioning means insertable into the pilot hole.

### BACKGROUND OF THE INVENTION

1. Field of the Invention

The invention relates to the field of drill guides for drilling holes in structures and, in particular, to a drill guide device that provides for a pilot hole in the structure to be properly aligned in the drive guide device so that the hole can be enlarged to its final size

2. Description of Related Art

Drill guide devices are old in the art. For example, U.S. Pat. No. 5,746,552 Adjustable Drill Bushing by g, Tsul, et al. discloses a drill bushing that can adjust the depth to which the drill extends. Another example is provided in U.S. Pat. No. 2,351,243 Combination Drill Guide and Clamp by J. Vetter which discloses a C shaped clamp having aligned and adjustable hollow drill guides that can be used to clamp the part in place and thereafter serve as a drive guide so that a hole can be accurately made. Other examples in the C clamp family are disclosed in U.S. Pat. No. 6,729,809 Combined Clamp And Drill Guide For The Elimination Of Inter-Laminate Burs During Drilling by B. Sarh, et al.

However, none of these devices is designed for use with structures having pilot holes pre-drilled therein. This is a major drawback, especially when drilling composite structures. Composite structures have a tendency to a greater tendency to breakout as the drill exits the structure. Thus initially small pilot holes are drilled to help eliminate this problem.

Thus, it is a primary object of the invention to provide a combination drill guide and clamp for drilling holes in structures.

It is another primary object of the invention to provide a combination drill guide and clamp for drilling holes in structures that have pilot holes.

It is a further object of the invention to provide a combination drill guide and clamp for drilling holes in structures that have pilot holes and that incorporate a system for aligning the pilot holes with drill.

### SUMMARY OF THE INVENTION

The invention is a device for drilling a structure having a pilot hole there through. In detail, the device includes a support member having first and second opposed ends, with the first and second opposed ends having aligned first and second threaded holes there through. First and second drill guides threadably engagable with the threaded holes in the first and second opposed ends of the support member, respectfully; the first and second drill guides having a hole there through. A positioning member having a pin, is insertable into the hole of either the first and second drill guides, such that when the structure is positioned between the first and second opposed ends, the pin of the positioning member is insertable in pilot hole.

Thus with said pin inserted in the pilot hole of the structure, the first and second drill guides can be translated into contact with structure securing it in place and after the positioning member is removed from the hole in either the first and second drill guides, a drill can be inserted into the hole for drilling a final sized hole in the structure.

In a second embodiment only one movable drill bushing is mounted in the first opposed end, while the second opposed end only has a through hole there through. The positioning member is inserted from the second opposed end for alignment of the structure and the movable drill bushing is used to clamp the structure to the second opposed end.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a partial cross-sectional view of the device with a composite structure having a pilot hole with an aligning device for aligning the pilot hole installed the drill bushing.

FIG. 2 is a view similar to FIG. 1 illustrating the composite structure with the pilot hole aligned with the drill bushing and clamped in place.

FIG. 3 is a view similar to FIG. 3 illustrating the structure being drilled.

FIG. 4 is illustrates an alternate version of the device

### DESCRIPTION OF THE PREFERRED EMBODIMENT

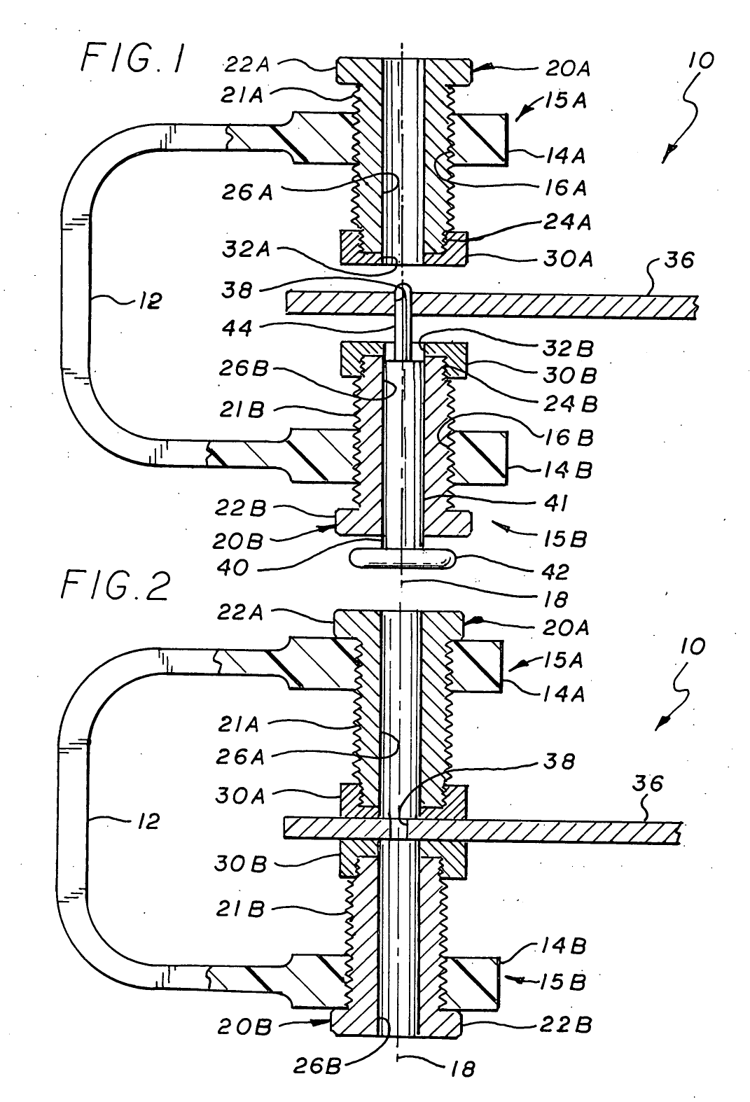

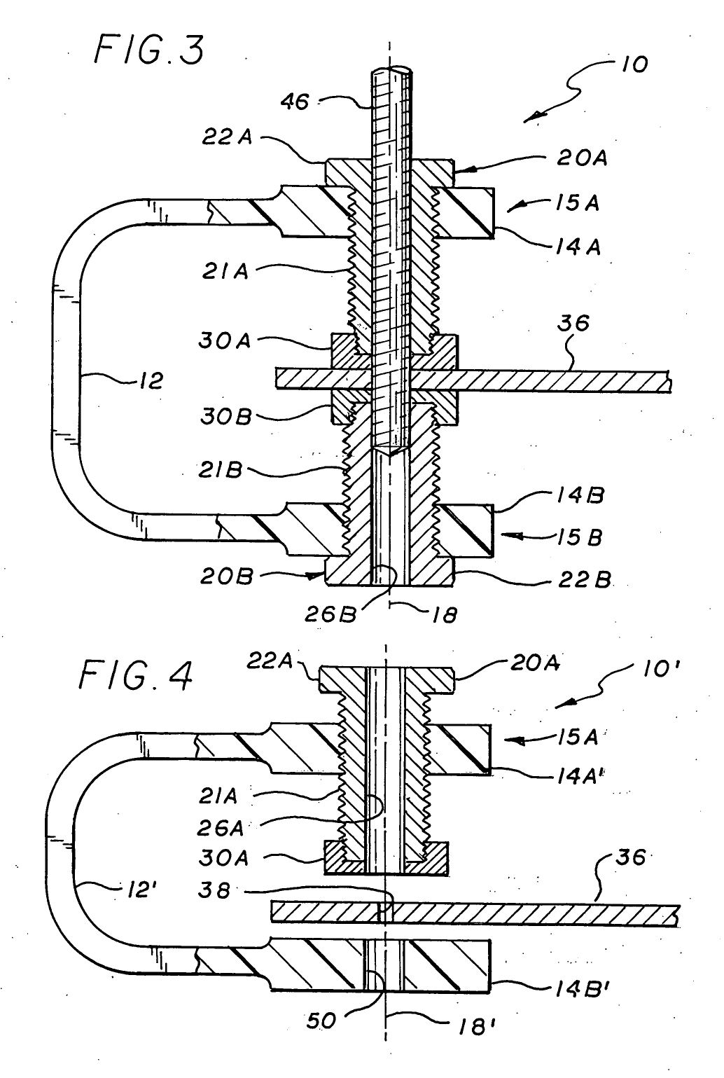

Referring to FIGS. 1-3, the device, generally indicated by numeral 10, includes a generally C shaped member 12 having opposed ends 14A and 14B. The ends 14A and 14B mount drill bushing assemblies 15A and 15B in threaded holes 16A and 16B with a common axis 18. The drill bushing assembly 15A includes a drill bushing 20A having mating external threads 21A installed in the threaded hole 16A, and further having a first end in the form of a knob 22A for rotating the bushing 20A advancing it toward end 14B and a second end 24A extending out of the opposed end 14A. A retaining cap 30A having a hole 32A threadably engages end 24A.

The drill bushing assembly 15B includes a drill bushing 20B having mating external threads 21B is installed in threaded hole 16B, and, and further having a first end in the form of a knob 22B for rotating the bushing 20B advancing it toward end 14A and a second end 24B extending out of the opposed end 14B. A retaining cap 30B having a hole 32B threadably engages end 24B.

The structure 36 to be drilled includes a pilot hole 38. To accurately drill out the pilot hole 38, the hole 38 must be accurately aligned with the common axis 18 of the threaded holes 16A and 16B of the member 12. This is accomplished by means of alignment member 40 having a center portion 41 and which includes first end having a knob 42 and a second end terminating in a pin 44 sized to fit into the pilot hole 38 of the structure 36. The center portion slidably engages bore 26B of the drill bushing 20B.

Thus with the structure 36 positioned between the ends 14A and 14B of the member 12, the alignment member 40 is inserted into the bore 26B of the drill bushing 20B until it extends out of the cap 30B. The structure 36 is moved until the pilot hole engages the pin 44. Thereafter drill bushings 20A and 20B can be rotated causing the caps 30A and 30B to engage the structure 36 locking it in place. Thereafter the alignment member 40 is removed and a drill 46 can be used to drill through the structure with the assurance that the structure is properly aligned. It should be noted that the alignment member 40 could be inserted through the drill bushing 20A to accomplish structure alignment.

Referring to FIG. 4, which discloses a second embodiment of the invention wherein only one drill bushing is used. As illustrated, the device 10′ includes a member 12′ having opposed ends 14A′ and 14B′, however only end 14A′ includes a drill bushing assembly 15A. End 14B′ includes a through hole 50 having a common axis 18′ with drill bushing assembly 15A. Here the alignment member 40 (not shown in FIG. 4) is inserted through the hole 50 for alignment of the structure 36, and clamping is accomplished by movement of the drill bushing 20A. This version is simpler, but looses some flexibility

While the invention has been described with reference to a particular embodiments, it should be understood that the embodiments are merely illustrative as there are numerous variations and modifications, which may be made by those skilled in the art. Thus, the invention is to be construed as being limited only by the spirit and scope of the appended claims.

### INDUSTRIAL APPLICABILITY

The invention has applicability to machine tool manufacturing industry.

1. A device for drilling a structure having a pilot hole there through, the device comprising:
a support member having first and second opposed ends, said first and second opposed ends having aligned first and second threaded holes there through;
first and second drill guides threadably engagable with said threaded holes in said first and second opposed ends of said support member, respectfully; said first and second drill guides having a hole there through; and
positioning means having a pin, said positioning means insertable into said hole of either said first and second drill guides, such that when the structure is positioned between said first and second opposed ends, said pin of said positioning means insertable into the pilot hole;
such that with said pin inserted I said pilot hole of the structure, said first and second drill guides can be translated into contact with structure securing it in place and after said positioning means is removed from said hole in either said first and second drill guides, a drill can be inserted into said hole for drilling a final sized hole in the structure.

2. The device as set forth in claim 1 wherein said first and second drill guides include knobs for aiding in the rotation thereof.

3. The device as set forth in claim 2 wherein said positioning means includes a knob at the end opposite said pin.

4. A device for drilling a structure having a pilot hole there through, the device comprising:
a support member having first and second opposed ends, said first and second opposed ends having aligned first and second there through, said first hole having internal threads;
a drill guide threadably engagable with said threaded hole in said first opposed end of said support member said drill guide having a hole there through; and
positioning means having a pin, said positioning means insertable into said hole of either said drill guide or said hole in said second opposed end, such that when the structure is positioned between said first and second opposed ends, said pin of said positioning means insertable into the pilot hole;
such that with said pin inserted into the pilot hole of the structure, said second drill guide can be translated into contact with structure securing it in place against said second opposed end and after said positioning means is removed from said hole in either said drill guide or said hole in said second opposed end, a drill can be inserted into said hole of said drill guide for drilling a final sized hole in the structure.

5. The device as set forth in claim 4 wherein said drill guide include knobs for aiding in the rotation thereof.

6. The device as set forth in claim 5 wherein said positioning means includes a knob at the end opposite said pin.
